(19) United States
(12) Patent Application Publication
(10) Pub. No.: US 2007/0207855 A1
(43) Pub. Date: Sep. 6, 2007

(54) Customized video poker

(76) Inventors: Ernst W. Moody, Las Vegas, NV (US); Michael Fields, Las Vegas, NV (US)

Correspondence Address: JOHN EDWARD ROETHEL, 2290 S. JONES BLVD. #100, LAS VEGAS, NV, 89146, US

(21) Appl. No.: 11/712,664

(22) Filed: Feb. 28, 2007

Related U.S. Application Data
(60) Provisional application No. 60/779,382, filed on Mar. 2, 2006.

(51) Int. Cl. A63F 13/00

(52) U.S. Cl. 463/31

(57) ABSTRACT

Customized templates for the video screen display 20 are provided to allow players to design their own personal video poker machines. A series of display screens can be accessed by the player to select the desired template from which the player will begin to create his customized screen display.

### CROSS-REFERENCE TO RELATED APPLICATION

This application is based on and claims the benefit of U.S. Provisional Application Ser. No. 60/779,382, filed Mar. 2, 2006, entitled “Customized Video Poker”.

This application relates to customized video poker and more particularly to customized video poker in which the player can configure the video poker machine both as to the game selection and play features as well as the overall appearance of the play screen display.

### BACKGROUND OF THE INVENTION

A well known game of chance offered to players in most gaming casinos is video draw poker. After making a wager, the player is dealt five cards face up. The player selects which cards, if any, the player wishes to hold, the unheld cards are discarded and replacement cards are dealt for the discarded cards. The final five card hand is analyzed to determine its poker hand ranking and the player is paid for winning poker hand rankings based on the amount of the player's wager. A pay table is displayed to the player showing the amounts that the player can win based on the poker hand ranking achieved by the player and the amount wagered by the player.

Video poker has also been adapted for play on gaming related web sites. Typically, the web site provides a video representation of a casino video poker machine. In those jurisdictions in which online casino gaming for real money is not permitted, the player plays the video poker game for amusement only and accrues credits or points that are not redeemable for monetary value. In other jurisdictions that permit online casino gaming for real money, the player plays the video poker game quite like the player would play in a gaming casino so that any credits or points that are accrued or won by the player can be cashed out for monetary value, either directly as cash or redeemable for non-cash awards or prizes.

Traditionally, in both the brick and mortar gaming casino version of video poker or in the online representation of video poker, the player has none or limited input in what games he can play or how the video poker screen display is shown to the player. Typically, the player is limited to selecting the denomination that the player will play for and the poker format of the game that the player will play.

One aspect of the present invention is to provide the player with many customizable features relating to the video poker game that the player will play. This will enhance the player's enjoyment during the play of video poker and provide a more pleasurable and satisfactory experience for the player.

Other aspects of the present invention will become apparent from a consideration of the following detailed description.

### SUMMARY OF THE INVENTION

In accordance with the present invention, customized templates for the video screen display 20 are provided to allow players to design their own personal video poker machines. A series of display screens can be accessed by the player to select the desired template from which the player will begin to create his customized screen display.

### BRIEF DESCRIPTION OF THE DRAWINGS

FIG. 1 shows a representative video poker gaming machine than may be customized in accordance with the present invention.

### DETAILED DESCRIPTION OF THE PREFERRED EMBODIMENTS

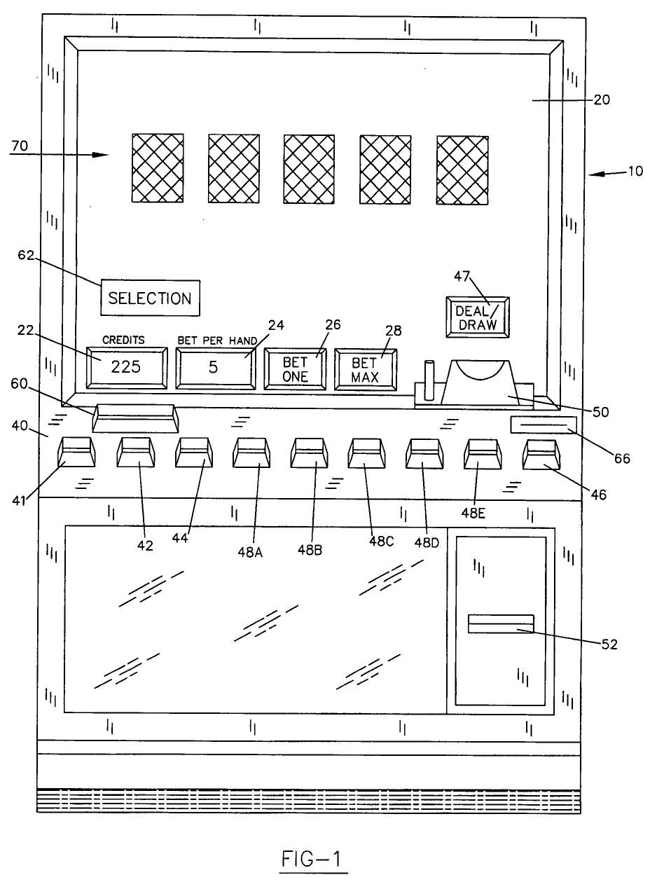

FIG. 1 shows generally at 10 a typical electronic video gaming machine that can be customized in accordance with the present invention. The electronic video gaming machine 10 includes a conventional coin head 50 into which the player can insert coins or gaming tokens and a slot 52 which leads to a conventional bill acceptor mounted on the interior of the gaming machine and into which the player can insert paper currency. As is also conventional in electronic video gaming machines, a credit meter display 22 is provided to show the amount of credits that the player has accrued on the gaming machine 10—either by inserting coins, tokens or paper currency or from winning plays achieved by the player. Whenever the player makes a wager, the amount of the wager is decremented from the credit meter display 22. Whenever the player achieves a winning play during the play of the game, the amount of the winning play is incremented on the credit meter display 22.

A conventional payout hopper is also located on the interior of the gaming machine and is used to dispense coins or tokens to the player into a payout tray 56 when the player wishes to collect any winning amounts the player has accrued. Other suitable and conventional payout mechanisms can be used, such as a ticket printer or other cashless payout devices.

The gaming machine 10 also includes a video screen display 20 of any suitable type upon which representations of playing cards are displayed. In a preferred embodiment of the present invention, one or more hands can be displayed on the video screen display 20 at the same time. As shown in FIG. 1, a first hand: HAND ONE 60 is shown. Each hand would preferably have five card locations preferably from left to right in a horizontal row, although other manners of displaying single or multiple hands can be used. The video screen display 20 also contains a location at which the amount wagered on each hand is shown, for example, “Bet Per Hand” 24.

A button panel 40 is also provided on the gaming machine 10 and the buttons mounted on the button panel 40 are used by the player to control the operation of the gaming machine 10. Any suitable configuration of the buttons on the button panel can be used and, alternatively, conventional touch screen technology can be used for any or all of the buttons mounted on the button panel.

A typical button arrangement is shown on the button panel 40 in FIG. 1. A “BET ONE” button 42 is provided to allow the player to wager one credit at a time. A “BET MAX” button 44 is provided to allow the player to wager the maximum amount of credits permitted by the configuration of the gaming machine 10. Any number of credits can be set as the maximum amount that it is possible to wager on each hand and, typically, five credits will be the maximum number of credits for any particular hand. Alternatively, a BET ONE location 26 and a BET MAX location 28 can be provided on the video screen 20 to allow the player to wager by using conventional touch screen technology.

A conventional “DEAL/DRAW” button 46 is also provided on the button panel 40 which is used by the player to activate the initial deal of the cards at the deal stage of the method of play or the dealing of replacement cards at the draw stage of the method of play as is appropriate. Similarly, a DEAL/DRAW location 47 can be provided on the video screen 20 to allow the player to effect either the deal step or the draw step by using conventional touch screen technology.

The button panel 40 is also provided with five “CARD” buttons 48A, 48B, 48C, 48D and 48E associated with each horizontal card location on the video screen display: card button 48A is associated with the left most card location, card button 48B is associated with the second from the left card location, card button 48C is associated with the middle card location, card button 48D is associated with the second from the right card location and card button 48E is associated with the right most card location. Each card button is preferably aligned below the card locations so that the player can easily associate the appropriate card button with the appropriate card location.

In accordance with the present invention, customized templates for the video screen display 20 are provided to allow players to design their own personal video poker machines. A series of display screens can be accessed by the player to select the desired template from which the player will begin to create his customized screen display.

For example, Player Sam A. Gaming sits down to play a game of video poker at a video poker gaming machine provided in a gaming casino. The player sees a selection button on the button panel 40 or a selection icon on the screen display 20 to build his own custom video poker machine. Sam then presses the button or the icon and is given a variety of choices.

Sam selects from a plurality of background choices a nice green background with subtle dollar signs shown as a watermark. Next Same chooses, from a group of possible card backs, a blue card back with his initials SAG displayed thereon. Of course, a wide selection of colors and indicia are available for the card backs.

Then Sam selects how he wises the face of the cards to be displayed. Again, there are a plurality of card face designs from which to choose. Same selects an old style IGT card face. Sam looks at a list of songs to play when his machine hits a jackpot and decides to go with Queen's “We are the Champions” from a suitable group of possible choices.

If Sam does not see any choices he likes in any or all of these categories, he can access from a variety of suitable web site which will allow him to upload other pictures, designs or text. Sam can also insert a USB flash drive that contains his own pictures, designs or text and use one or more of those to customize the screen display. For example, he can put pictures of his kids on the backs of the cards and add his school fight song as the music to be played with his wins a jackpot or suitable award.

Besides selecting the video poker format that Sam A. Gaming wishes to play, the can also select a pay table from a list of available pay table and Sam is able to chose the pay outs for Royal Flushes and Fours-of-a-Kind. For example, Sam decides to go with a double royal flush pay out and he gives up a lower pay for a flush.

Some of the pay tables available to Same let him have his own personal progressive jackpots. For example, Sam picks a pay table that gives him a progressive payout for the Royal Flush or for four Aces.

Sam can also select a sponsor such as Red Bull that would make him eligible for an additional progressive jackpot in exchange for using Red Bull on the card backs. Or the Red Bull symbol might randomly appear on the card faces and act as a multiplier whenever Sam achieves a winning payout.

Sam can also select a satellite radio station to listen to over headphones when he is playing at the casino.

When he is done with his selections he is able to play the game for free on the videopoker.com web site.

Sam's custom machine display can be changed at any time while he is playing the machines in the casino. In accordance with the present invention, Sam can design more than one custom machine display. Any of the custom screen displays designed by Sam can be stored in a computer memory location either on the gaming machine that he is playing or on a master hard drive maintained by the gaming casino or even the gaming machine manufacturer. This will allow any of Sam's personal designs to be recalled by him for play at any other time either on the same gaming machine at that gaming casino, on other gaming machines at that gaming casino or on any other suitably equipped gaming machine at other gaming casinos.

In one aspect of the game design storage feature, Sam can be provided with his own account at the gaming machine manufacturer and, by means of a personalized player card, account number, password or the like, Sam would be able to access his customized game display designs and download them or call them up onto the gaming machine that Sam is playing regardless of the physical location of the gaming machine. For example, when Sam goes to a gaming casino that accepts the manufacturer's card, he puts it in a slot on the gaming machine and one or more of Sam's customized game screen displays comes up. Sam can then use in his casino players card to get his player rewards. Alternatively, the casino specific players card can also be coded directly to Sam's customized player profile with the gaming machine manufacturer.

Sam's customized player profile can be different for each different casino at which Sam plays. He could have his own personal progressive payouts at each different casino. A particular casino, for example, could offer Sam special payouts or rewards, such as a bonus progressive payout, whenever Sam uses his customized video screed display when he plays video poker at that particular casino.

The player's customized screen display machine could also be used to keep track of the results of Sam's play. For example if Sam missed hitting a royal flush, the gaming machine could be configured to send Sam a notice by email or even snail mail or to call him on his cell phone to come down to the gaming casino on a certain day and get another shot at the four to the royal. The gaming machine could also be programmed to play a number of face down mystery bonus hands at random. The player would have to return to the casino at a later date to see the results of these hands played face up to see if he won anything.

Besides providing for customized gaming machines at brick and mortar gaming casinos, the present invention can also be applied in a wireless mode through a portable gaming device supplied by the casino or the player could play it on his laptop computer from his hotel room.

Likewise, Player Sam A. Gaming can also design a customized gaming screen display whenever he plays online either for real money or for amusement only at any of the various online gaming sites. Typical of an online gaming site that allows play for amusement only is the www.videopoker.com web site.

When Sam logs on to www.videopoker.com, he would see a button or other indictor that would prompt Sam to build his own custom video poker machine. Same would proceed in the manner discussed above to create a customized video poker display that he could use whenever he visited www.videopoker.com. All of the features discussed above could also be used at this online video poker site.

When Sam is done with his selections he is able to play the game for free on the www.videopoker.com web site.

The present invention can be used with the traditional Draw Poker format as well as with any other variations of draw poker, such as Deuces Wild Poker, Bonus Poker, Double Bonus Poker, Double Double Bonus Poker, Triple Bonus Poker, Joker's Wild Poker or any of the myriad of video poker formats that have been developed. Each of these video poker formats uses various arrangements of poker hand rankings as winning combinations and they use various payout amounts for the poker hand rankings. The present invention can be applied to any of the various video poker formats previously used, currently in use or created for use in the future.

While the invention has been illustrated with respect to several specific embodiments thereof, these embodiments should be considered as illustrative rather than limiting. Various modifications and additions may be made and will be apparent to those skilled in the art. Accordingly, the invention should not be limited by the foregoing description, but rather should be defined only by the following claims.

What is claimed is:

1. A customizable video screen display for a gaming machine which is capable of displaying a casino game such as video poker comprising:
a) a selection button on the gaming machine so that a player may select from a menu of custom features;
b) the menu of custom features including:
1) a plurality of selectable background images;
2) a plurality of selectable background colors;
3) a plurality of card back designs;
4) a plurality of card face designs; and
5) a plurality of sound files that will activate at certain stages of play of the casino game.

2. The customizable video screen display of claim 1 further including a USB slot on the gaming machine so that the player may upload to the gaming machine from a flash drive a player's personalized files whereby the video screen display can be customized.

3. A customizable touch screen video screen display for a gaming machine which is capable of displaying a casino game such as video poker comprising:
a) a selection location on the touch screen video screen display on the gaming machine so that a player may select from a menu of custom features;
b) the menu of custom features including:
1) a plurality of selectable background images;
2) a plurality of selectable background colors;
3) a plurality of card back designs;
4) a plurality of card face designs; and
5) a plurality of sound files that will activate at certain stages of play of the casino game.

4. The customizable video screen display of claim 3 further including a USB slot on the gaming machine so that the player may upload to the gaming machine from a flash drive a player's personalized files whereby the video screen display can be customized.
